(19) United States
(12) Patent Application Publication
(10) Pub. No.: US 2004/0150739 A1
(43) Pub. Date: Aug. 5, 2004

(54) Apparatus and method for digital close-up photograph of surfaces

(75) Inventor: Takashi Shinozaki, Yokohama (JP)

Correspondence Address: Derma Medical Inc., 11-26, 2 chome,, Nagata-minami, Minami-ku, Yokohama, Kanagawa, 232-0073, JP

(73) Assignee: Derma Medical Inc., Yokohama (JP)

(21) Appl. No.: 10/355,982

(22) Filed: Feb. 1, 2003

(51) Int. Cl. H04N 5/225

(52) U.S. Cl. 348/335

(57) ABSTRACT

This invention relates to an apparatus and method for in vivo monitoring and digitally recording of surfaces of the human body and etc.

A kit for modifying a digital camera, to perform close-up photography attached to a camera. A close-up adapter unit has a lamp inside for lighting. The battery unit with light SW is mounted on the digital camera. The close-up adapter consists of the second lens and the optical glass, which is located at the shorter distance than the focal length of the second lens. The images can be taken under the same conditions like the white balance and the focus. The system is designed for easy and foolproof operation with the two separate units of the close-up adapter and batteries, two-way DC supply methods, the mark of the direction on the photograph, SW system, and the cover for knobs and buttons.

### CROSS-REFERENCE TO RELATED APPLICATIONS

U.S. patent documents:

| | | |
|---|---|---|
| U.S. Pat. No. | 7/1998 | 5,950,017 |
| | 10/1998 | 5,825,502 |
| | 7/1998 | 5,781,807 |

### BACKGROUND OF THE INVENTION

1. Field of the Invention

The invention concerns an apparatus that allows the recording of digital close-up still images and video signals using a digital camera, also denoted as magnified images, of surface details like human skin, flesh, meat, and plant. Using the Personal Computer, the digital images are played back on the computer monitor.

The apparatus allows the doctors to closer view at the images of the skin surfaces. The system preferred for medical application, particularly in dermatology, is described here.

2. Description of the Related Art

The method commonly used for the investigation of skin areas is the direct visual observation with a hand-operated dermatoscope. One of the disadvantages of this method is that the observation is only seen by one person. Another disadvantage is that no permanent record of the observation is simply taken.

Recently a digital still camera became popular for various applications. A digital camera can also shoot at the surface of the skin. However, it is difficult to get the fine focusing and stable images and to avoid the reflected light from the skin.

The system is required for lighting to shoot the skin surface. The halogen lamp tube for lighting is useful to get a better color reproduction.

### BRIEF SUMMARY OF THE INVENTION

There are many digital cameras in the market. The focal range that can be focused on the subject varies like from ¾ inch to infinity or from 11 inches to infinity.

To get the stable picture of a subject like the skin, the attachment of the digital camera system should be contacted directly to the skin. Therefore, the distance between the second lens and the skin can be kept constant. The subject is usually located below the skin, in other words, below the skin surface. To avoid the reflected light from the skin surface, the gel or water or other liquid is used between the skin surface and optical glass of the attachment. The fine focus is key to get the high-resolution images. The invention method to get the stable high-resolution images is to set the second lens so that the focal length is longer than the distance between the second lens and the optical glass. The lamp for lighting is built inside the attachment. The battery for the lamp is separately packed into the unit with SW for lamp. When necessary, the SW for the lamp will be “ON” by depressing it.

### BRIEF DESCRIPTION OF THE SEVERAL VIEWS OF THE DRAWINGS

A more complete appreciation of the invention and of the advantages thereof will be obtained by reference to the following detailed description considered in connection with the accompanying drawings.

FIG. 1 shows that the second lens works like the subject's distance being infinite and the magnifying the image as the former method.

FIG. 2 shows the close-up adapter unit has the optical glass for the touch to the skin and the built-in lamp for lighting. The gel or water or other liquid prevents the reflected light from the skin surface.

FIG. 3 shows the close-up system for the digital camera. The close-up adapter and battery units are mounted on the digital camera.

FIG. 4 shows a partial enlarged front view of the camera of FIG. 2 and the detailed view of the close-up adapter unit.

FIG. 5 shows a partial enlarged view of the front cover for the attachment unit.

FIG. 6 shows the DC supply to the lamp from the AC adapter for the different application.

FIG. 7 shows the protector for the knobs and buttons to prevent to be changed the factory calibration.

### DETAILED DESCRIPTION OF THE INVENTION

As far as the digital close-up still image system using a digital camera concerns, the product life of the digital camera is usually short. Sometime the digital camera model may be discontinued. Therefore, the modification kit for the digital close-up still image system must be redesigned to fit with the new digital camera.

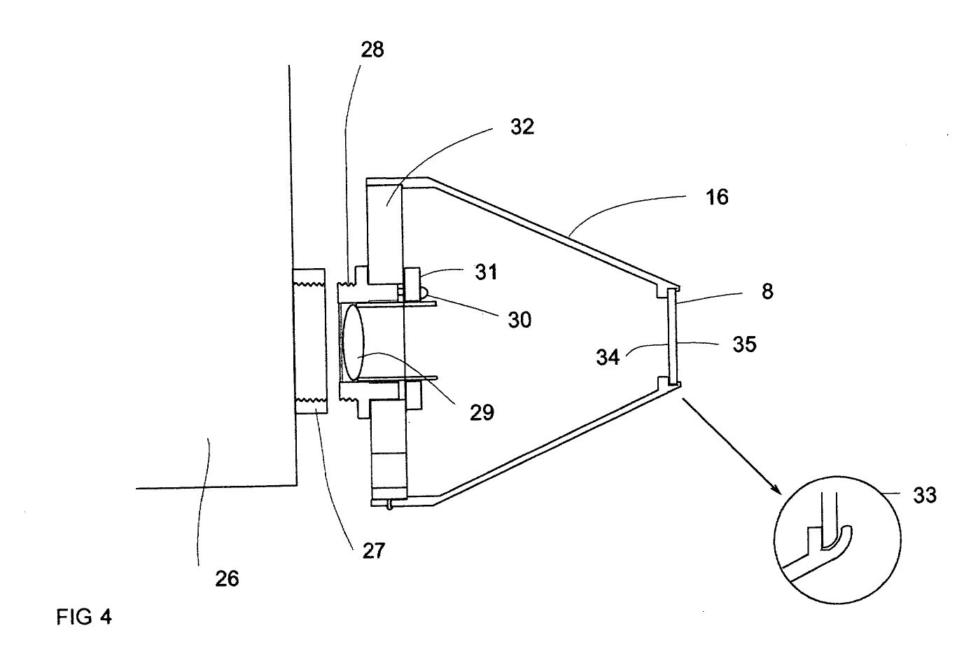

For that solution, the part of 28 at the FIG. 4 can be redesigned to fit with the new filter screw (diameter and pitch) of the new digital camera. This 28 is a machine part.

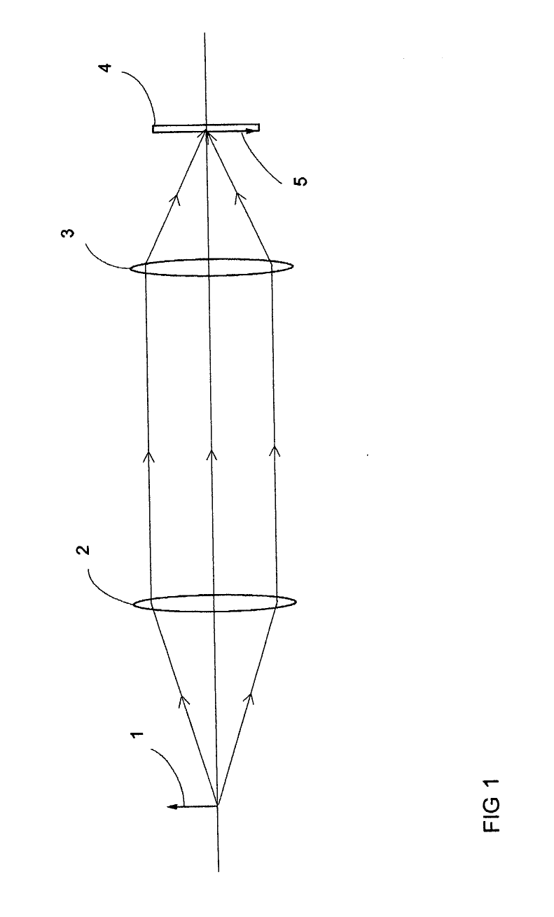

Therefore, the cost difference is small. Most of the parts like the cover, base, and battery case are made from the plastic. The system is very lightweight and easy to operate. To focus on the short distance subject, usually macro mode function is available at the digital camera. Although the focal range of any digital camera is from 1 meter to infinity. This close-up photograph system with the invention method is realized. Using the second lens, if the subject 1 is put to near the focus point of the second lens 2, the light lay from the subject become parallel like the lay comes from infinity. (Refer to FIG. 1) The digital camera lens 3 can focus the image 5 of the subject on CCD sensor 4.

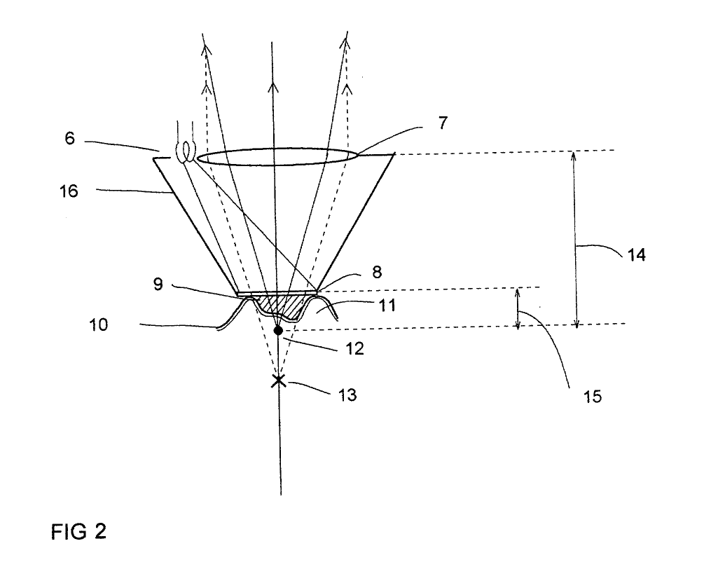

In other words, the digital camera focuses the subject at the infinite distance. U.S. Pat. No. 5,825,502 is using the same principle. The FIG. 2 shows the invention system. Using the second lens 7, the subject 12 underneath the skin surface 10 is taken. It is important that practically the optical glass 8 is put before the focal point 13 of the second lens. For instance, if the focal length 13 of the second lens 7 is 100 mm, the distance between the glass 8 and the lens 7 is 76 mm. Then, the subject 12 is away from the glass due to some boil 11 which thickness is, for instance, about 10 mm. It is necessary to use the gel 9 to prevent reflected light. The distance 15 between the lens 7 and the subject 12 is within the focal length of the second lens 7. In other words, the distance 15 between the glass and the subject should be more than 10 mm. Normally the optical glass 8 is pushed to the surface of the skin 10 to take the photograph after the gel 9 is coated on the skin.

This close-up adapter unit is basically covered by the corn-shaped cover 16 at the FIGS. 2 & 3 to shut off the outside light. The subject will be dominated by the lamp lighting inside the cover. The still images can be taken under the stable conditions about the white balance and the focus.

When checking and printing the memorized images, it is difficult to recognize the horizontal and vertical directions of the image. In addition to that, it is necessary to get the position of the connector for DC power source at the upside of the camera. Therefore, the adjustment method for setting the positions of the mark and connector is required. Referring to the FIG. 4, 26 is the digital camera and 27 is the filter screw of the lens.

This starting position of filter screw is not constant. The screw cylinder 28 of the second lens can be screwed into the filter screw 27. Finally the screw will be stopped due to the screw end. This end position depends on the starting position of the filter screw.

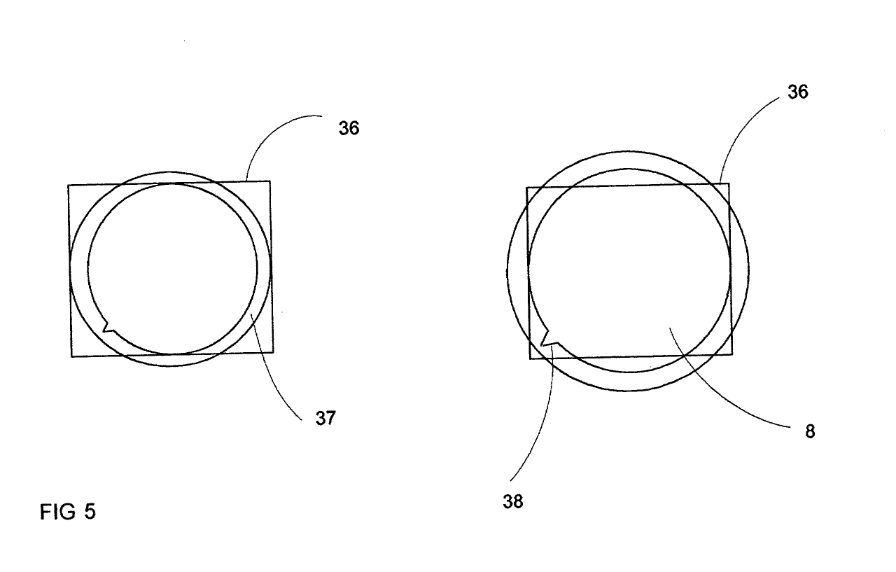

Then, the end position becomes random. The base 32 is sandwiched and fixed by the screw cylinder 28 and the metal plate 31 that has the spring effect. 8 is the optical glass. 36 frame of the glass, which is the front part of the cover 16 at the FIG. 4, is marked at the corner of left bottom side at the FIG. 5 (38). As this mark is near the focal point, the image of the mark is clear and can be easily recognized as the mark. After the position of the connector and the mark is adjusted to be expected, the screws 30 fix the base 32.

The glass 8 is fixed by the cover 16 without using the adhesive. The cover is treated with heat like 33. The cover is made from the plastic material POM (Polyoxymethylene) to be resistant to the alcohol for cleaning the glass after a diagnosis. The glass 8 gets AR coating to prevent the reflection at the surface of 34 side. The other side 35 of the glass has no coating because the gel will be used between the skin and the glass. Then, the coating is unnecessary.

At the FIG. 5, the frame 36 of 4:3 aspect ratio means that the monitor can display the image of the inside of the frame. The circle of the inside means the optical glass 8 and then this area can be shown as the image. Usually for the zoom position it is recommendable to set either position as the left or right figures. The right figure shows the circle is inscribed horizontally. The left figure shows the circle 37 is inscribed vertically.

In either case the mark is shown at left bottom side. Then, the printed photograph can show the mark.

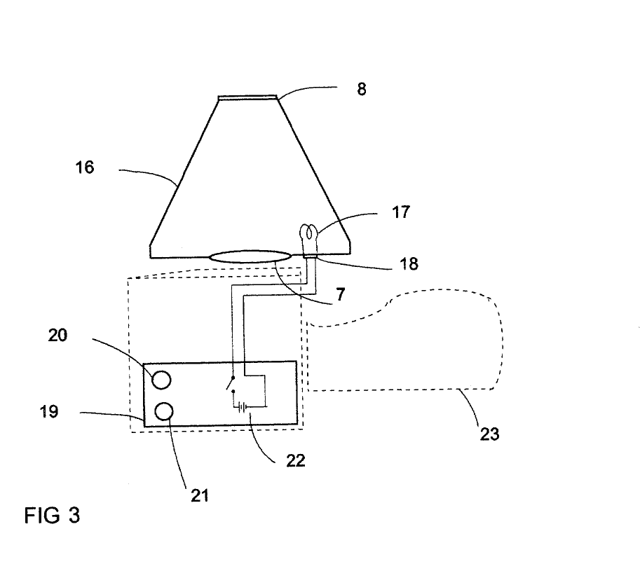

The next is lighting system. The FIG. 3 shows the dry cell battery system. The close-up unit consists of the cover 16, the optical glass 8, the second lens 7, and the lamp 17. The battery unit 19 consists of SW 20, the screw 21, and batteries 22. 23 is the digital camera. 22 dry cell battery (Alkaline 1.5V×2) supplies DC to lamp 17 through SW 21 and 18 connector. This SW lights a lamp only when depressed. This prevents the consumption of the batteries and the chance that the battery life will be consumed if SW not turned off.

When carrying the digital camera system, it is better to disconnect the connector 18 to prevent the accidental depression of SW. This feature comes from the lamp and battery separation system.

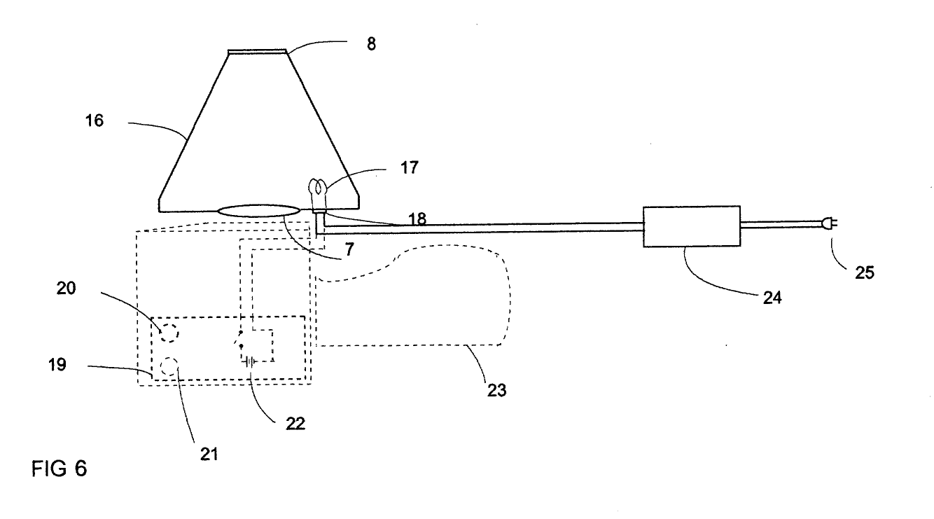

The FIG. 6 is showing that AC adapter 24 which gets AC power from plug 25 supplies DC power constantly instead of dry cell battery to the lamp. The battery unit is fixed by the male screw 21 to the digital camera. The female screw of the digital camera is for the optional flash.

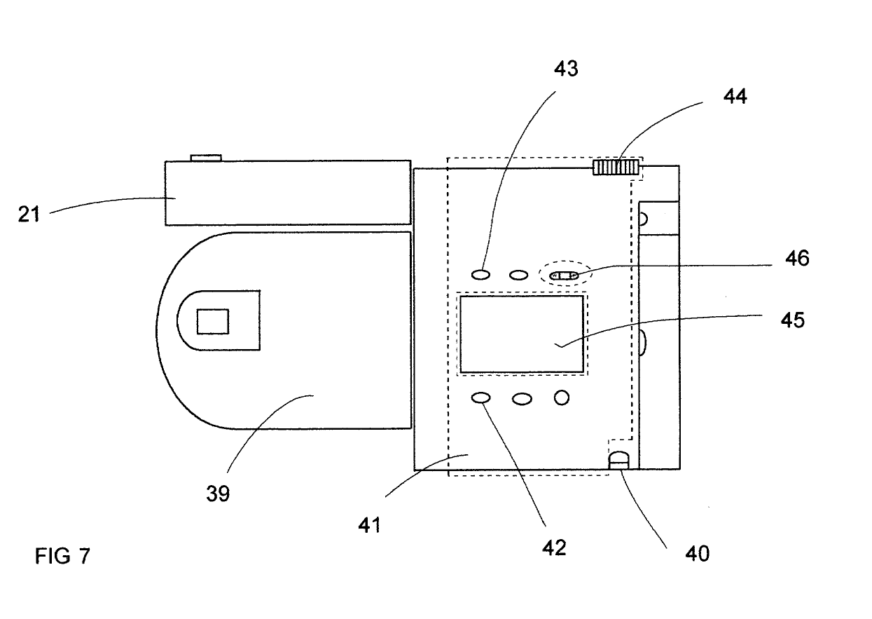

The FIG. 7 is showing that the cover is used to protect the buttons and knobs when the sophisticated settings are determined.

Usually the semi-professional digital camera has many functions and parameters to be calibrated to get the best photographs for the applications. For the FIG. 7, the battery unit 21 is mounted on the digital camera 39. The cover 41 protects knobs 42, 43, 44 and etc.

The open area 45 is the window for LCD display and the knob 46 is for zoom adjustment. The cover is fixed by using the tripod female screw. Using the hanger 42 for the strap the cover is stopped to be rotated. Instead of this method, it is also possible that the independent covers protect the two or three knobs and buttons.

What is claimed is:

1. An apparatus and method for close-up photograph and real time video or digital recording of an object surface, particularly of a soft surface on a large object, for example human skin, flesh, meat, and plant, comprising a digital camera with an objective which can be adjusted for point-blank range to infinite object distance, an additional lens system connected to the camera objective, a distance-enforcing structure, which shuts off the outside lighting, connected to the lens system which allows to take a close-up photograph even at very close distance by setting the optical glass between the second lens and the focal length of the second lens.

2. An apparatus as set forth in claim 1, where the glass of the close-up adapter unit is fixed to the cover, which material is POM (Polyoxymethylene), by being treated with heat without using an adhesive. Then, the alcohol can be used for cleaning because of the POM which is resistant to the alcohol.

3. An apparatus as set forth in claim 1, where the glass of the close-up adapter unit has the AR coating inside the cover to prevent the reflection of the light. The other side of the glass has no coating.

4. An apparatus as set forth in claim 1, where the close-up adapter unit is fixed to the digital camera by the screw to get the stable images in a body.

5. An apparatus as set forth in claim 1, where the recorded images are marked by the engraved frame. The image gets the mark at the corner which part has no effective image.

6. An apparatus as set forth in claim 1, where the close-up adapter unit has the mechanism to set the phase of the position of the connector for DC power source and the mark for the image to the digital camera.

7. An apparatus as set forth in claim 1, where the system consists of the two units. The DC power supply has two-way methods as the dry cell batteries and the AC adapter.

8. An apparatus as set forth in claim 1, where the lighting SW is activated by being depressed to avoid the unnecessary consumption of the batteries. The disconnection of the DC power connector can avoid the accidental activation of the power during the transfer.

9. An apparatus as set forth in claim 1, where holding the digital camera system and depressing the SW with two hands can get the stable images.

10. An apparatus as set forth in claim 1, where the cover for the knobs and buttons protects the accidental adjustments and the modifications made by knowledgeable persons. The other cover type is the small size protectors for two or three knobs and buttons.
